(19) United States
(12) Patent Application Publication
(10) Pub. No.: US 2006/0123192 A1
(43) Pub. Date: Jun. 8, 2006

(54) Information Recording/Reproducing Method and Apparatus

(75) Inventor: Shinichiro Uno, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/275,027

(22) Filed: Dec. 2, 2005

(30) Foreign Application Priority Data
Dec. 7, 2004 (JP) 2004-354146

(51) Int. Cl. G06F 13/00

(52) U.S. Cl. 711/113; 711/163

(57) ABSTRACT

Provided is an information recording/reproducing method and apparatus which can reduce the frequency of access to an information recording medium as much as possible and shorten reading/writing time. An application program or a file system driver has a means for setting a predetermined area in the cache buffer area to overwrite inhibited. Thus, when the data to be read out again is set to overwrite inhibition, the data is not deleted from the cache buffer. Therefore, access to the disk is not caused at the time of re-reading or re-writing, which can shorten reading/writing time.

### BACKGROUND OF THE INVENTION

1. Field of the Invention

The present invention relates to an information recording/reproducing apparatus for recording or reproducing information in a recording medium such as an optical disk, and more particularly to an information recording/reproducing apparatus such as a camcorder or a DVD recorder.

2. Related Background Art

Conventionally, a disk recording/reproducing apparatus such as a camcorder or a DVD recorder is provided with a cache buffer for temporarily storing data read out from a disk. With the use of the cache buffer, if the data to be read out from the disk exists in the cache buffer, the data can be taken out from the cache buffer without access to the disk. A conventional technique related to the cache buffer is disclosed in, for example, Japanese Patent Application Laid-Open No. 2001-014109.

As to the conventional cache buffer technique, data to be stored cannot be controlled through an application program or a file system, and old data is merely substituted by newly read data. Therefore, the technique has a problem in that, even if the data planned to be read again does not exist on the cache buffer, access to a disk is caused at the time of re-reading, which takes time. In the technique disclosed in Japanese Patent Application Laid-Open No. 2001-014109, weighting is performed to data in a cache buffer area, and overwriting is performed in order from the data with the minimum weight. The technique increases a possibility that necessary data remains in the cache. However, the application program or file system cannot specifically designate the data for overwriting since weighting is automatically carried out.

### SUMMARY OF THE INVENTION

The present invention has been made in view of the above, and therefore has an object to provide an information recording/reproducing method and apparatus which can reduce the frequency of access to an information recording medium as much as possible and shorten reading/writing time.

The information recording/reproducing method and apparatus of the present invention are as follows.

The information recording/reproducing method includes the steps of:

storing data read out from a recording medium, into a cache buffer; and

setting the data stored in the cache buffer to overwrite inhibited.

Further, the information recording/reproducing apparatus includes:

a controller for giving an instruction on recording/reproducing data in/from a recording medium;

a cache buffer for storing the reproduced data; and

a circuit for setting the data stored in the cache buffer to overwrite inhibited.

### BRIEF DESCRIPTION OF THE DRAWINGS

FIG. 1 is a block diagram of a structure of an embodiment of an information recording/reproducing apparatus according to the present invention;

FIG. 2 shows an example of conventional data arrangement on a memory;

FIG. 3 shows data arrangement on a memory according to the present invention;

FIG. 4 is a flow chart of a procedure of reading data according to the present invention;

FIG. 5 is a flow chart of a procedure of writing data according to the present invention;

FIG. 6 shows data arrangement on a disk according to the present invention;

FIG. 7 shows an example of actual data arrangement on a memory according to the present invention;

FIG. 8 shows an example of actual commands according to the present invention; and

FIG. 9 explains movement of a recording/reproducing head at the time of real-time recording according to the present invention.

### DESCRIPTION OF THE PREFERRED EMBODIMENTS

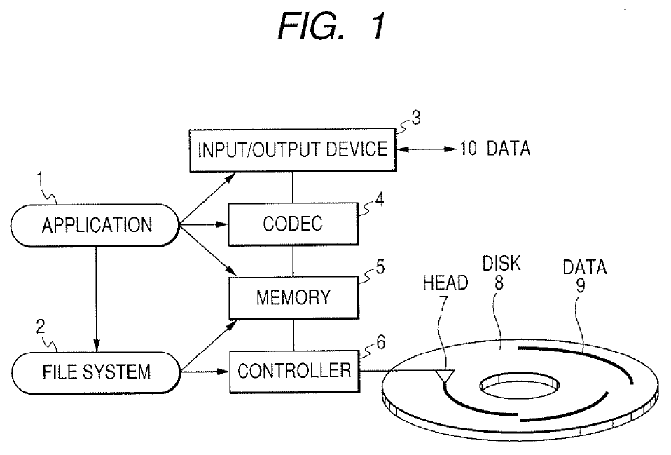

Description will be made of the best mode for implementing the present invention in detail with reference to the drawings. FIG. 1 is a block diagram of showing a structure of an embodiment of an information recording/reproducing apparatus according to the present invention. In the figure, reference numeral 1 denotes an application program, which controls input/output of data 10 through an input/output device 3, and instructs a codec 4 to encode and decode the data 10. Also, the application program 1 stores coded data on a memory 5, and instructs a file system driver 2 to perform recording, reproducing, editing, or the like to data on a disk 8 as an information recording medium such as an optical disk. A cache buffer area is provided in the memory 5.

The file system driver 2 checks a free area on the disk 8 and a recording position of a file to instruct a disk controller 6 to perform reading/writing of data to the disk 8. At this point, the application program 1 does not need to consider the position of the data on the disk 8. The file system driver 2 searches for the free area on the disk 8 for recording, or retrieves the position of the data on the disk 8 for reading.

The disk controller 6 writes the data stored in the memory 5 to the disk 8, or reads data from the disk 8 to the memory 5. Data 9 is actual data written on the disk 8, and reading/writing of data from/to the disk 8 is performed by means of a recording/reproducing head 7. In this embodiment, one file may be recorded in a continuous area, or plural sets of data may be recorded in different areas. A group of data recorded in a continuous area, which forms a part of the file is referred to as an extent.

Further, as described later, the application program 1 and the file system driver 2 each have a function of setting predetermined data in the cache buffer to “overwrite inhibited”. Thus, when the data to be read out again is set to “overwrite inhibited”, the data is not deleted from the cache buffer. Therefore, access to the disk 8 is not caused at the time of re-reading or re-writing, which can shorten reading/writing time.

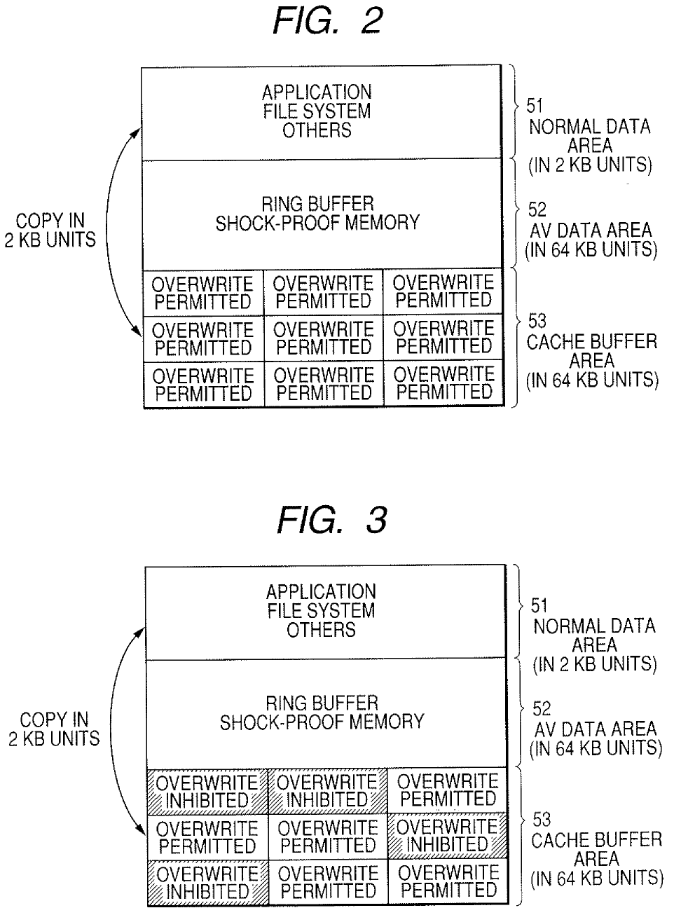

FIG. 2 is a diagram of data arrangement on a memory as a conventional example. Three areas of a normal data area 51, an AV data area 52, and a cache buffer area 53 exist on the memory, as shown in FIG. 2. An area used by hardware and the like may also be provided, but are omitted in this embodiment. The cache buffer area 53 is an area for subjecting AV data read from a disk to ECC decoding and temporarily storing the data, and is provided in units of 64 KB. Here, newly read data is overwritten on old data, and the latest data is always stored.

Further, the cache buffer area 53 temporarily stores information on the position and size of data (static-image data, text data, etc.) except AV data and a file recorded on a disk, that is, management information of a file system, and stream management information on a relationship between position and size, attribute and the like of the AV data.

The normal data used in the application and the file system is recorded on the disk in sector units (2 KB). Then, when an instruction for reading normal data is issued from the application, necessary data in the data recorded in 64 KB units written on the cache buffer is copied on the designated part (normal data area) on the memory in 2 KB units.

The AV data is originally recorded on the disk in 64 KB units, and thus, can be directly written to the designated part (AV data area) on the memory not through the cache buffer. At the time of real-time recording/reproducing of the AV data, the area is used as a ring buffer, and also has a function of a shock-proof memory.

In the case where the instruction for reading data is given from the application, when an ECC block (in 64 KB units) including data exists on the cache, data is read from the cache without access to the disk. However, when the ECC block does not exist on the cache, data is newly read from the disk.

Further, in the case where the instruction for writing data is given from the application, when the data exists oh the cache, only a necessary part of the data may be rewritten to be returned to the disk. However, when the data does not exist on the cache, it is necessary that the ECC block including the corresponding data is first read from the disk, and a necessary part of the data is rewritten to be returned to the disk.

FIG. 3 is a diagram of data arrangement on the memory according to this embodiment. It is the same as in the conventional example of FIG. 2 that there exist the three areas of the normal data area 51, the AV data area 52, and the cache buffer area 53. Functions of the respective areas are also the same as those of FIG. 2. However, this embodiment is different from the conventional example in a point that the instruction from the application program 1 or the file system driver 2 can set the data written in the cache buffer area 53 to “overwrite inhibited” in 64 KB units.

That is, the cache buffer area 53 includes an overwrite-inhibited portion and an overwrite-permitted portion. The data newly read from the disk 8 is first overwritten on the old data in the overwrite-permitted portion, and the data in the overwrite-inhibited portion remains on the memory 5 until an instruction is given. Accordingly, the data frequently read or rewritten such as management data can be left in the cache buffer area, thereby reducing the number of times of access to the disk 8.

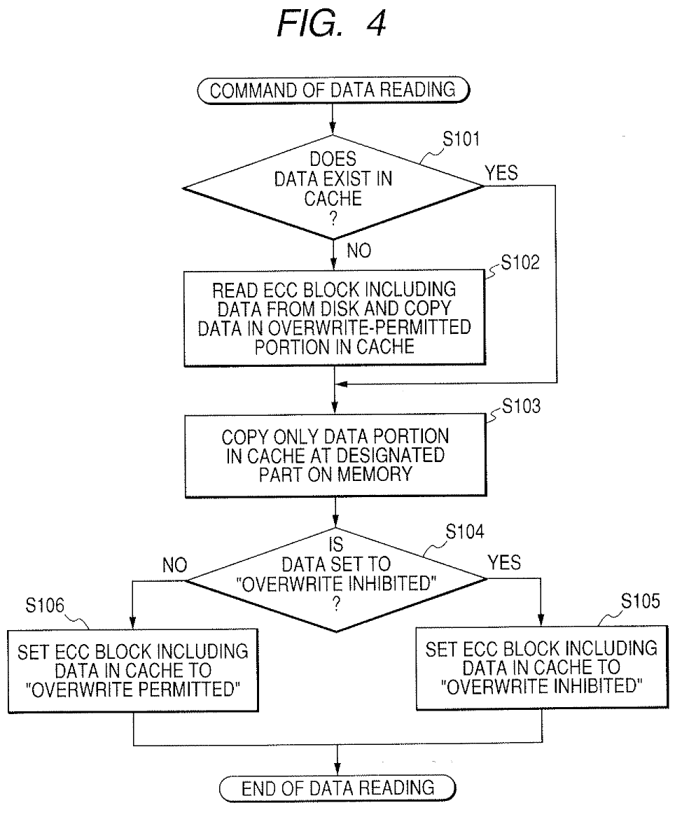

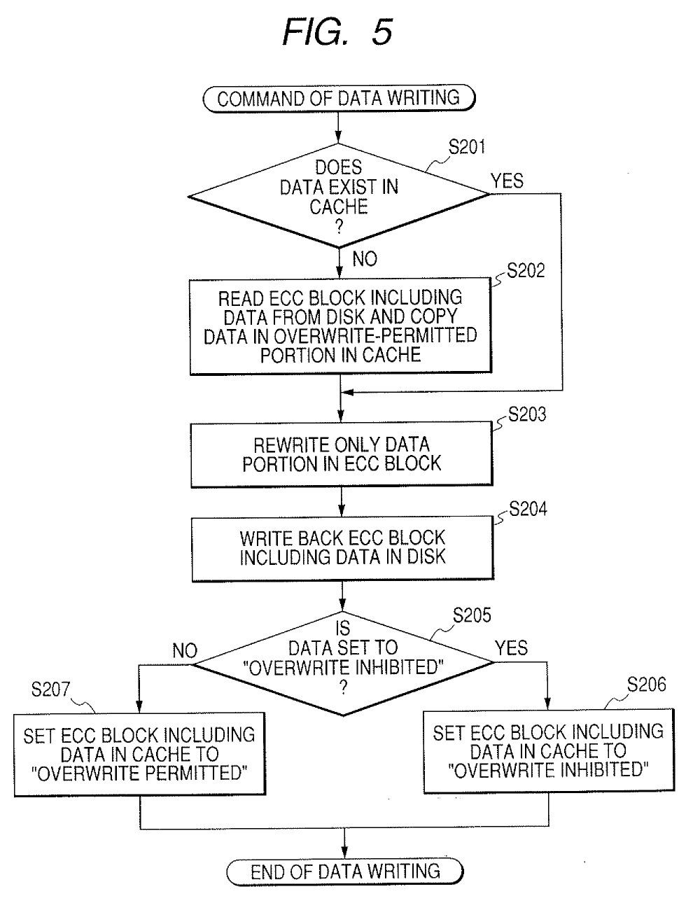

FIGS. 4 and 5 are flowcharts of respective procedures of reading/writing data from/to the disk 8 according to this embodiment. FIG. 4 shows the data reading procedure. When being issued from the application program 1, a data reading command is sent to the disk controller 6 through the file system driver 2. The disk controller 6 manages the cache buffer area 53, and judges whether the designated data (2 KB) exists in the cache buffer area 53 or not (S101). When the designated data exists, the corresponding data in the cache is copied at a designated position in the memory (S103). When the designated data does not exist, the ECC block (in 64 KB units) including the data is read from the disk 8 to be copied in the overwrite-permitted portion in the cache buffer area 53 (S102), and then, the corresponding data is copied at the designated position in the memory 5 (S103).

Subsequently, judgment is made on whether the read data is designated as overwrite-inhibited data by the application program 1 or the file system driver 2 (S104).

When the data is set to “overwrite inhibited”, the ECC block including the corresponding data in the cache buffer area 53 is set to “overwrite inhibited” (S105). When the data is not set to “overwrite inhibited”, the ECC block is set to “overwrite permitted” (S106).

Note that the data to be designated as overwrite-inhibited data is previously determined.

For example, the data certain to be used again such as management data is previously determined, and is designated as overwrite-inhibited data on the cache buffer.

FIG. 5 shows the data writing procedure. When being issued from the application program 1, a data writing command is sent to the disk controller 6 through the file system driver 2. The disk controller 6 manages the cache buffer area 53, and judges whether the ECC block (in 64 KB units) including an address to be written exists in the cache buffer area 53 or not (S201).

At this point, when the objective address exists in the cache buffer area 53, the data (2 KB) in the corresponding part is rewritten (S203), and the rewritten data is written into the disk 8 in ECC block units (S204). On the other hand, when the address does not exist, the ECC block including the corresponding address is once read in the cache buffer area 53 from the disk 8, and is copied in the overwrite-permitted portion in the cache buffer area 53 (S202). Thereafter, the data in the corresponding part is rewritten in the same manner (S203), and the rewritten ECC block is returned to the disk 8 (S204).

Subsequently, a judgment is made on whether the written data is designated as overwrite-inhibited data by the application program 1 or the file system driver 2 or not (S205). At this point, when the data is designated as overwrite-inhibited data, the ECC block including the corresponding data in the cache buffer area 53 is set to “overwrite inhibited” (S206). When the data is not designated as overwrite-inhibited data, the ECC block is set to “overwrite permitted” (S207).

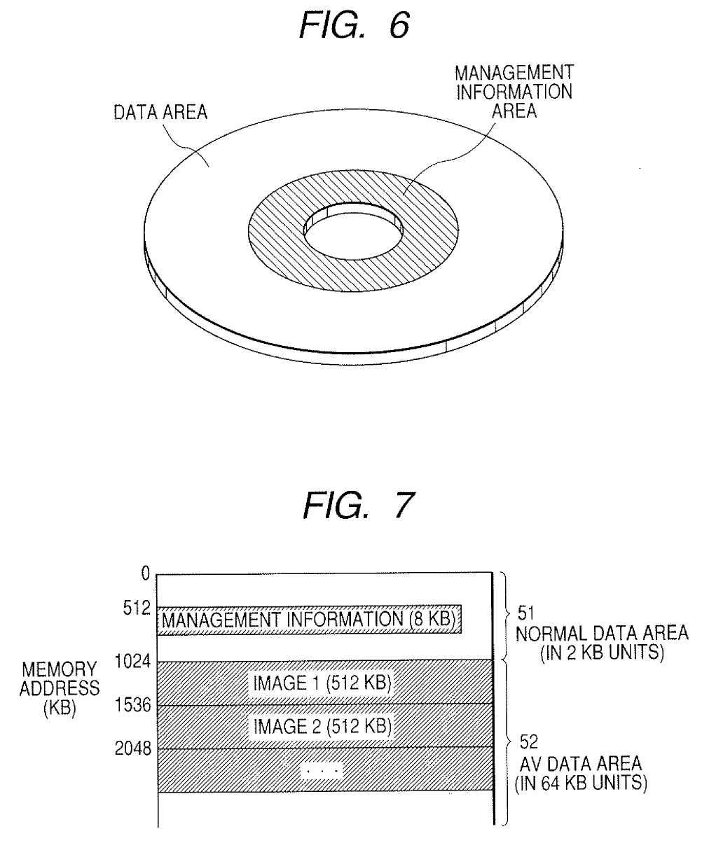

Next, description will be made of effectiveness of the present invention by using specific examples. FIG. 6 shows data arrangement on the disk 8. In order to improve an access speed of the disk 8, the management information for the application program 1, the file system driver 2, and the like is concentratedly arranged in an inner circumferential area of the disk 8, and normal data is recorded in an outer area. As a result, for example, in the case where the management information is collectively read at the time of insertion of the disk 8 or in the case where the management information is updated on the midway, long-distance seek of the recording/reproducing head 7 is not generated, thereby making it possible to shorten access time.

FIG. 7 shows an example of data arrangement on the memory 5 on the midway of recording at the time when an image is actually recorded on the disk 8. The image is disposed in the AV data area 52, and the management information of, for example, the file system that manages the image is disposed in the normal data area 51. In FIG. 7, image data is disposed in and after a memory address 1024 KB. For the sake of convenience, the image data is shown in division in 512 KB units as units for a writing command to the disk 8. Further, the management information, which is the file system information, is arranged in the normal data area 51 with a size of 8 KB from the position of a memory address 512 KB.

When it is considered that AV data is actually written into the disk 8 in a real-time manner, there is the case where processing is performed which updates the file system every constant time as measures against instantaneous disconnection during writing. With the processing, even if the data on the memory 5 disappears due to generation of instantaneous disconnection, the data immediately before update of the file system can be reproduced in the disk 8.

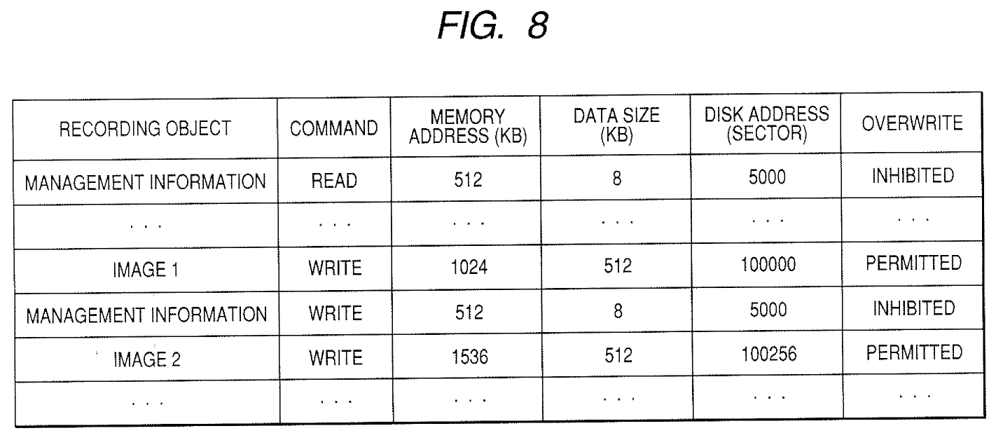

FIG. 8 shows examples of commands of reading/writing data from/to the disk 8 at this point. There are commands of reading (Read)/writing (Write) from/to the disk 8. There are four parameters of memory address, data size, disk address, and the above setting of “overwrite inhibited”. The memory address and the data size are indicated in KB units, and the disk address is indicated in sector units (2 KB).

First, management information such as related directory information is read out from the disk 8 in order to record the image. As shown in FIG. 8, the management information for 8 KB is read from a sector address 5000 on the disk 8 to the memory address 512 KB.

At this point, the ECC block for 64 KB including the management information for 8 KB is read from the disk 8. The management information needs to be read again from the disk 8 at the time of update, and thus, is set to “overwrite inhibited” on the cache buffer area 53. As a result, the information does not need to be read again. Note that, in the case where the management information such as the image file management information is newly formed, and does not originally exist on the disk 8, a procedure of reading the management information is omitted.

Next, as to a procedure of recording an image in the disk 8, management information (file system information) is updated while the image is recorded in the disk 8. That is, an image 1 is recorded in the disk 8 for 512 KB, and then, the updated management information is recorded for 8 KB. Subsequently, an image 2 is recorded for 512 KB. At this point, the memory addresses and data size, which serve as recording sources, are as shown in FIG. 7. In the case of recording image data, a sector address on the disk 8 as a recording address is recorded in an outer circumferential part (100000, 100256) of the disk 8, and the management information is recorded in an inner circumferential part (5000).

A 256 sector on the disk 8 corresponds to 512 KB. Thus, the 100256 sector corresponding to a recording start position on the disk 8 of the image 2 is the next sector to a recording completion position on the disk of the image 1. Further, as to the management information for 8 KB, when the ECC block including the update part does not exist on the cache buffer area, the corresponding portion needs to be read out from the disk 8 once. In this case, the ECC block read in the previous time has been set to “overwrite inhibited”, and thus, invariably exists on the cache buffer area. Therefore, it is sufficient that the update portion be rewritten to be returned to the disk 8. Moreover, the update portion is also set to “overwrite inhibited” here. However, the update portion may be set to “overwrite permitted” if it is not necessary hereafter.

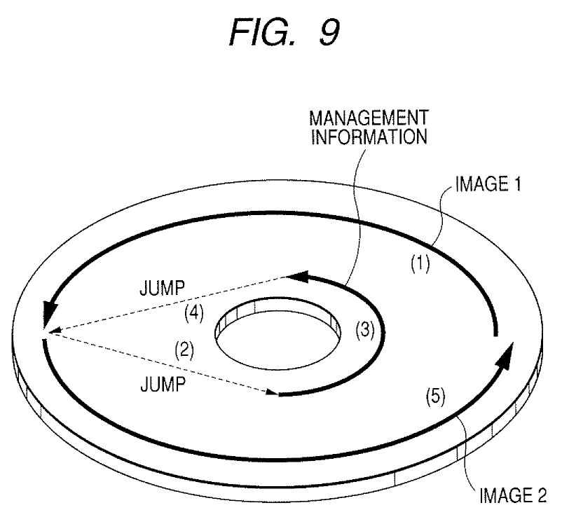

Movement of the recording/reproducing head 7 on the disk 8 at this point is shown in FIG. 9. Reference numerals in the figure show the order of movement of the recording/reproducing head 7. First, the image 1 is recorded (1). Then, update of the file system is performed as measures against instantaneous disconnection during the image recording, and thus, a jump is conducted to the management information area (2). After the file system information is updated (3), a jump is performed to the end of the image on the midway of recording (4). Then, recording of the image 2 is resumed (5).

At this point, in the update of the file system information, when the ECC block including the update portion does not exist on the cache buffer area, the corresponding portion needs to be read out from the disk 8 once. The processing of (3) causes troublesome procedures of reading the pre-updated data from the disk 8 and writing the updated data into the disk 8.

In the case where the management information of the file system and the like is updated every constant time as described above, the corresponding portion needs to be read out from the disk 8 once if the ECC block including the management information does not exist on the memory. However, there is a possibility that real-time recording ends in failure due to the time required for the reading procedure

In this embodiment, when the ECC block including the management information is previously set to “overwrite inhibited” in the cache buffer area, the data to be rewritten invariably exists in the memory. Therefore, the procedure of reading data from the disk 8 can be omitted, so only a writing operation has to be performed for disk access. Accordingly, there is remarkably reduced a possibility that real-time recording ends in failure.

This application claims priority from Japanese Patent Application No. 2004-354146 filed on Dec. 7, 2004, which is hereby incorporated by reference herein.

What is claimed is:

1. An information recording/reproducing method, comprising the steps of:
storing data read out from a recording medium into a cache buffer; and
setting the data stored in the cache buffer to overwrite inhibited.

2. The information recording/reproducing method according to claim 1, wherein a memory area of the cache buffer is controlled in units of ECC block size, and the step of setting to overwrite inhibited is performed in the units of ECC block size.

3. An information recording/reproducing apparatus comprising:
a controller for giving an instruction on recording/reproducing data in/from a recording medium;
a cache buffer for storing the reproduced data; and
a circuit for setting the data stored in the cache buffer to overwrite inhibited.
